(19) United States
(12) Patent Application Publication
(10) Pub. No.: US 2020/0065869 A1
(43) Pub. Date: Feb. 27, 2020

(54) DETERMINING SHARED RIDE METRICS

(71) Applicant: General Motors LLC, Detroit, MI (US)

(72) Inventor: Robert E. Tiderington, Grosse Pointe Farms, MI (US)

(21) Appl. No.: 16/111,704

(22) Filed: Aug. 24, 2018

(51) Int. Cl. G06Q 30/02; G06Q 10/02; G06Q 20/22

(52) U.S. Cl. CPC G06Q 30/0284; G06Q 20/29; G06Q 10/02

(57) ABSTRACT

A system and method of determining a shared ride metric for a plurality of shared ride members of a shared ride, the method including: establishing a shared ride reservation for the shared ride; determining that more than one shared ride member is participating in the shared ride such that a plurality of shared ride members are participating in the shared ride; and when it is determined that more than one shared ride member is participating in the shared ride: (i) determining a shared ride metric for two or more of the plurality of shared ride members, each of the shared ride metrics being associated with one of the two or more shared ride members, and (ii) notifying each of the two or more shared ride members of an associated shared ride cost based on the associated shared ride metric.

### INTRODUCTION

The present invention relates to determining a shared ride metric for a plurality of shared ride members of a shared ride.

Vehicles include hardware and software capable of obtaining and processing various information, including information that is obtained by vehicle system modules (VSMs). Moreover, vehicles include networking capabilities and can be connected to a vehicle backend server that maintains accounts for users and their vehicles. Users may allow another user to borrow their vehicle or to lease their vehicle, or to carry out ride sharing with another individual.

### SUMMARY

According to one aspect of the invention, there is provided a method of determining a shared ride metric for a plurality of shared ride members of a shared ride, the method including: establishing a shared ride reservation for the shared ride; determining that more than one shared ride member is participating in the shared ride such that a plurality of shared ride members are participating in the shared ride; and when it is determined that more than one shared ride member is participating in the shared ride: (i) determining a shared ride metric for two or more of the plurality of shared ride members, each of the shared ride metrics being associated with one of the two or more shared ride members, and (ii) notifying each of the two or more shared ride members of an associated shared ride cost based on the associated shared ride metric.

According to various embodiments, this method may further include any one of the following features or any technically-feasible combination of some or all of these features:
determining whether more than one shared ride member is contributing to a total shared ride payment, wherein each of the shared ride member(s) that are contributing to the total shared ride payment is a shared ride contributing member;
when it is determined that more than one shared ride member is contributing to the total shared ride payment, then determining a shared ride metric for at least one shared ride contributing member, and wherein the two or more shared ride members are the shared ride contributing members;
the shared ride metrics for each of the two or more shared ride members is a shared ride cost metric;
the shared ride cost metric is or represents a proportion of a total shared ride payment for the shared ride;
the shared ride cost metric is or represents shared ride member shares;
the associated shared ride cost is or is the same as the shared ride cost metric;
the shared ride cost metric for each of the two or more shared ride members is determined based on receiving input information from at least one of the two or more shared ride members, and wherein the input information is generated at the vehicle using a vehicle user interface and/or at one or more personal short-range wireless communications (SRWC) devices of the at least one shared ride member;
the input information is received at a remote facility from the vehicle or from the one or more personal SRWC devices, and wherein the remote facility carries out the step of determining the shared ride cost metric for each of the two or more shared ride members;
identifying one or more individuals at the vehicle based on information received from one or more onboard vehicle sensors, and wherein the step of determining that more than one shared ride member is participating in the shared ride is based on the identifying step;
the one or more onboard vehicle sensors includes a camera mounted on the vehicle, wherein the identifying step includes processing image data obtained by the camera at a remote facility;
the method is carried out by a remote facility that includes one or more servers, and wherein each of the one or more servers includes a processor and memory; and/or
the processor of at least one of the one or more servers is configured to carry out a shared ride backend services application, the shared ride backend services application including computer instructions that, when executed by the processor of at least one server, causes the remote facility to carry out the method.

According to another aspect of the invention, there is provided a method of determining a shared ride metric for a plurality of shared ride members of a shared ride, the method including: establishing a shared ride reservation for the shared ride; identifying two or more of the plurality of shared ride members that are participating in the shared ride; when more than one shared ride member is identified as participating in the shared ride, obtaining a shared ride metric for each of the two or more identified shared ride members, each of the shared ride metrics being associated with one of the two or more shared ride members; and notifying each of the two or more shared ride members of an associated shared ride cost based on the associated shared ride metric.

According to various embodiments, this method may further include any one of the following features or any technically-feasible combination of some or all of these features:
the identifying step includes linking each of the plurality of shared ride members to the shared ride as each of the plurality of shared ride members are identified;
the identifying step includes identifying at least one of the two or more shared ride members based on information indicating a presence of a personal short-range wireless communications (SRWC) device associated with the at least one shared ride member at the vehicle;
each of the shared ride metrics is based on associated loyalty information;
the shared ride metric is obtained based on onboard vehicle sensor information;
each of the shared ride metrics is a shared ride participation time or a shared ride participation mileage; and/or
confirming the associated shared ride cost through receiving a confirmation message from one or more of the two or more shared ride members.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a flowchart of an embodiment of a method of determining a shared ride metric for a plurality of shared ride members of a shared ride; and

FIG. 3 is a flowchart of another embodiment of a method of determining a shared ride metric for a plurality of shared ride members of a shared ride.

### DETAILED DESCRIPTION

The system and method described below enables determining a shared ride metric for a plurality of shared ride members of a shared ride. In some scenarios, multiple individuals may desire to participate in a shared ride as shared ride members and, thus, according to at least one embodiment, when it is determined that there is more than one shared ride member, a shared ride metric for each shared ride member can be determined or otherwise obtained. A shared ride refers to using a vehicle as a part of a ride sharing service or a car sharing service, which are discussed more below, and a shared ride member refers to a person that is participating in a shared ride as a customer. In some scenarios, when multiple shared ride members are participating in a shared ride, the shared ride members may desire to allocate a total shared ride payment (or cost) between them. One or more of the shared ride members can then specify a shared ride cost metric, which can be a breakdown or allocation of the total shared ride payment. In some embodiments, vehicle sensor information can be used to determine shared ride cost metrics, which can be used as a basis in determining the shared ride cost metric for each shared ride member. And, additionally or alternatively, a loyalty status for each shared ride member can be determined and then used to determine the shared ride cost metric for each shared ride member.

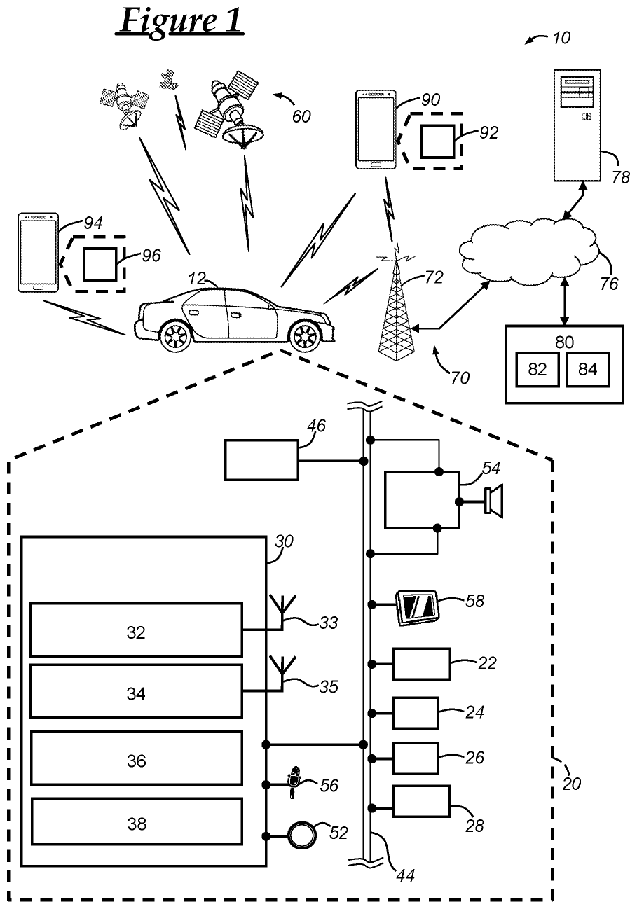

With reference to FIG. 1, there is shown an operating environment that comprises a communications system 10 and that can be used to implement the method disclosed herein. Communications system 10 generally includes a vehicle 12 with a wireless communications device 30 and other VSMs 22-56, a constellation of global navigation satellite system (GNSS) satellites 60, one or more wireless carrier systems 70, a land communications network 76, a computer or server 78, a vehicle backend services facility 80, and personal SRWC devices 90, 94. It should be understood that the disclosed method can be used with any number of different systems and is not specifically limited to the operating environment shown here. Also, the architecture, construction, setup, and general operation of the system 10 and its individual components are generally known in the art. Thus, the following paragraphs simply provide a brief overview of one such communications system 10; however, other systems not shown here could employ the disclosed method as well.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12). Carrier system 70 can implement any suitable communications technology, including GSM/GPRS technology, CDMA or CDMA2000 technology, LTE technology, etc. In general, wireless carrier systems 70, their components, the arrangement of their components, the interaction between the components, etc. is generally known in the art.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to vehicle backend services facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof.

Computers 78 (only one shown) can be some of a number of computers accessible via a private or public network such as the Internet. Each such computer 78 can be used for one or more purposes, such as for providing peer-to-peer (P2P) vehicle sharing services to a plurality of vehicles and other electronic network computing devices, including vehicle 12 and personal SRWC devices 90, 94. Other such accessible computers 78 can be, for example: a service center computer where diagnostic information and other vehicle data can be uploaded from the vehicle; a client computer used by the vehicle owner or other subscriber for such purposes as accessing or receiving vehicle data or to setting up or configuring subscriber preferences or controlling vehicle functions; a shared ride server which coordinates registrations from a plurality of users who request to use a vehicle as part of a car sharing or ride sharing service; or a third party repository to or from which vehicle data or other information is provided, whether by communicating with the vehicle 12, remote facility 80, or both. A computer 78 can also be used for providing Internet connectivity such as DNS services or as a network address server that uses DHCP or other suitable protocol to assign an IP address to vehicle 12.

Vehicle backend services facility 80 is a remote facility, meaning that it is located at a physical location that is located remotely from vehicle 12. The vehicle backend services facility 80 (or “remote facility 80” for short) may be designed to provide the vehicle electronics 20 with a number of different system back-end functions through use of one or more electronic servers 82 and, in many cases, may be a shared ride server (or application) that is used to communicate information between one or more personal SRWC devices 90, 94 and/or one or more vehicles 12. This shared ride server can carry out various shared ride backend services, and the “shared ride backend services” can include managing and facilitating the establishment and execution of shared ride reservations. For example, these shared ride backend services can include determining vehicle availability, identifying one or more members that are participating in a shared ride, user account management for users of the shared ride network (or vehicle network), storing shared ride metric data, determining shared ride cost metrics (or other shared ride metrics), charging members of a shared ride, and/or other various shared ride functionality as made apparent from the discussion below.

The vehicle backend services facility 80 includes vehicle backend services servers 82 and databases 84, which may be stored on a plurality of memory devices. Also, remote facility 80 can include one or more switches, one or more live advisors, and/or an automated voice response system (VRS), all of which are known in the art. Vehicle backend services facility 80 may include any or all of these various components and, preferably, each of the various components are coupled to one another via a wired or wireless local area network. Remote facility 80 may receive and transmit data via a modem connected to land network 76. Data transmissions may also be conducted by wireless systems, such as IEEE 802.11x, GPRS, and the like. Those skilled in the art will appreciate that, although only one remote facility 80 and one computer 78 are depicted in the illustrated embodiment, numerous remote facilities 80 and/or computers 78 may be used.

Servers 82 can be computers or other computing devices that include at least one processor and that include memory. For example, one or more of the servers 82 can be shared ride servers. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware, which enable the servers 82 to provide a wide variety of services. In one embodiment, the servers 82 can execute a shared ride backend application (and can be considered shared ride servers) that enables various shared ride functionality, including the shared ride backend services discussed above. This software may be stored in computer-readable memory such as any of the various types of RAM (random access memory) or ROM (read only memory). For network communications (e.g., intra-network communications, inter-network communications including Internet connections), the servers can include one or more network interface cards (NICs) (including wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. Remote facility 80 can include a number of routers, modems, switches, or other network devices that can be used to provide networking capabilities, such as connecting with land network 76 and/or cellular carrier system 70.

Databases 84 can be stored on a plurality of memory, such as a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and magnetic or optical disc drives. One or more databases at the backend facility 80 can store various information and can include a shared ride database, geographical roadway information database, and other vehicle backend information database(s).

The shared ride database can include various information for use in the shared ride backend services application and/or for other uses. The shared ride information can be stored on one or more databases 84, and these databases can be referred to as shared ride databases. The shared ride information can include user account information, vehicle reservation information, vehicle availability information, shared ride metric data (e.g., data concerning or representing shared ride cost metrics or other shared ride metrics), vehicle location information, and/or vehicle specification information. The user account information can include various information for use in maintaining and facilitating the share ride services network, such as account credentials (including username, password, other authentication/authorization information, facial recognition data, and/or other security information), subscription information, loyalty information, and/or payment preferences and financial account information. The loyalty information can be a loyalty status and/or loyalty credits. The loyalty status can indicate a level or tier of loyalty achieved (or attributed) to a particular shared ride user, and the loyalty points can be credits or points attributed to a particular shared ride user. In some embodiments, the loyalty status and/or loyalty credits can be used to determine a shared ride metric for a particular shared ride member and/or to determine a cost metric for a shared ride member. In one embodiment, the loyalty credits can be used by a shared ride member to pay for a shared ride, or may be used to redeem coupons and/or discounts that can be used for a shared ride or other related shared ride services.

The vehicle availability information can include a vehicle availability indicator (i.e., an indicator that indicates whether the vehicle is available for reservation) and other vehicle status information. The vehicle location information can include information representing the vehicle's location, including geographical coordinate information that is received from the vehicle and that is generated at the vehicle through use of global navigation satellite system (GNSS) services (e.g., through use of GNSS receiver 22). The vehicle specification information can include information concerning specifications of the vehicle, such as make, model, model-year, standard features, optional features, aftermarket features, vehicle system module (VSM) information (e.g., vehicle sensor information), vehicle networking information (e.g., networking or user equipment (UE) information, including wireless subscriber information of a telematics unit or other UE, supported networking functionality, device identifiers and/or addresses), and various other information pertaining to a particular vehicle, such as the vehicle 12. It should be appreciated that any or all of the information stored in the shared ride database can be stored at one or more databases at one or more locations or facilities, and which may be operated and/or managed by one or more associated entities, including an OEM of the vehicles.

Additionally, in one embodiment, databases 84 can include geographical map information including geographical roadway map data that digitally represents geographical areas including roadways on the surface of earth. The geographical roadway map data includes data representing geographical regions including data representing roadways among the geographical regions. The geographical roadway map data can include various additional information, such as roadway dimensions and geometries (e.g., information representing geographical areas in which roadways are located), roadway attributes (e.g., speed limit, permitted direction of travel, lane information, traffic signal information), roadway conditions (e.g., present or estimated traffic conditions, predicted and/or observed weather conditions among the roadway), and various other information. Any of the geographic roadway map data can be associated with geographical coordinates or other location-identifying information that can be used to tie the data to a particular geographical point or area. Other information can be stored at the vehicle backend services facility 80, including account information such as vehicle services subscriber information (e.g., credentials and authentication information), vehicle identifiers, vehicle transactional information, geographical coordinates of the vehicle, and other vehicle information. Any or all of this information can be included and/or associated with information stored in the shared ride database(s), as discussed above.

The servers 82 can be used to provide the P2P vehicle sharing information as well as other information stored in the databases 84, including the geographical roadway map data, to a plurality of vehicles, including vehicle 12. Vehicle 12 can use this information to carry out a shared ride (or shared ride reservation), as well as various other vehicle functionality. As mentioned above, although only a single vehicle backend services facility 80 is illustrated, numerous vehicle backend services facilities can be used and, in such a case, the functionality of the numerous vehicle backend services facilities can be coordinated so that the vehicle backend services facilities can act as a single backend network.

The personal SRWC devices 90 and 94 are mobile devices and may include: hardware, software, and/or firmware enabling SRWC as well as other personal (or mobile) device applications. In one embodiment, the personal SRWC devices 90, 94 can include a shared ride member application 92, 96 and a global navigation satellite system (GNSS) receiver. Additionally, or alternatively, the personal SRWC devices 90, 94 can include a vehicle-device application that enables the personal SRWC devices 90, 94 to connect directly to the vehicle 12 via SRWCs. In some embodiments, the vehicle-device application and the shared ride member application can be integrated into a single application, or may be associated with one another such that information can be communicated therebetween. According to various embodiments, the personal SRWC devices can include Android™, iOS™, Windows™ Phone, Windows™ Mobile, BlackBerry™, Tizen™, and/or other various operating systems. In one particular embodiment, the personal SRWC devices can be personal cellular SRWC devices that each include a cellular chipset and/or cellular connectivity capabilities, as well as SRWC capabilities. Using a cellular chipset, for example, the personal SRWC devices 90, 94 can connect with various remote devices, including computers 78 and remote server facility 80, via wireless carrier system 70. As used herein, a personal SRWC device is a mobile device that is capable of SRWC, that is portable by a user, and where the portability of the device is at least partly dependent on the user, such as a wearable device (e.g., a smartwatch), an implantable device, or a handheld device (e.g., a smartphone, a tablet, a laptop). As used herein, a short-range wireless communications (SRWC) device is a device capable of SRWC. The hardware of SRWC mobile devices 90 may comprise: a processor and memory (e.g., non-transitory computer readable medium configured to operate with the processor) for storing the software, firmware, etc. The personal SRWC device's processor and memory may enable various software applications 92, 96, which may be preinstalled or installed by the user (or manufacturer) (e.g., having a software application or graphical user interface (GUI)).

As mentioned, the personal SRWC devices 90, 94 can include a processor and memory. The processor (or processing device) can be any type of device capable of processing electronic instructions including microprocessors, microcontrollers, host processors, controllers, and application specific integrated circuits (ASICs). The processor of the personal SRWC devices 90, 94 executes various types of digitally-stored instructions, such as software or firmware programs stored in memory of the personal SRWC device, which enable the devices 90, 94 to provide a wide variety of services. The memory of the personal SRWC device may be a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and magnetic or optical disc drives.

One implementation of shared ride member applications 92, 96 may enable the personal SRWC device to carry out variations of the method discussed herein. In one embodiment, the personal SRWC device 90 can be used to determine a location of the vehicle 12. Such devices may communicate with wireless communications device 30 or with each other according to one or more SRWC technologies or wired connections, such as a connection using a Universal Serial Bus (USB) cable.

In one embodiment, the personal SRWC devices can include a GNSS receiver (not shown) that can be used to receive a plurality of GNSS signals from a plurality (or constellation) of GNSS satellites 60. The GNSS receiver can then use certain techniques to obtain a coordinate location of the personal SRWC device, which can include a latitudinal coordinate, a longitudinal coordinate, and/or an elevation coordinate or height. A more detailed discussion of a SRWC circuit 32 and a GNSS receiver 22, which are installed in the vehicle 12, is provided below and, to the extent such discussion is not inconsistent with the discussion of devices 90, 94 above, it is incorporated herein and hereby attributed to the personal SRWC devices 90, 94.

In one embodiment, the personal SRWC device 90 may be a shared ride member device and can be used by a shared ride member, which is a person that is participating in a shared ride as a customer (or someone agreeing to provide payment or other consideration to participate in a shared ride). And, a shared ride contributing member is a person agreeing to contribute to a total shared ride payment. A shared ride operator is a person that is operating the vehicle 12 as a part of a shared ride and, in some embodiments, the shared ride operator may also be a shared ride member; however, in other embodiments, such as when ride sharing is used, the shared ride operator is not a shared ride member. For example, the shared ride member can rent the vehicle 12 (i.e., reserved use of the vehicle 12 in exchange for payment or other consideration) through use of the share ride network. In one embodiment, the shared ride member can use their personal SRWC device 90 to carry out the shared ride member application 92 that can be used with the shared ride network, such as for reserving a vehicle of the shared ride network or for establishing a ride sharing reservation. In some embodiments, a plurality of shared ride members can participate in the same shared ride and, in such a case, a single shared ride member may initially establish the shared ride reservation. In such a scenario, the shared ride member that initially established the shared ride reservation can be a primary shared ride member.

The shared ride member application 92 can be a ride sharing application and/or a car sharing application that is used by a user of the shared ride network for purposes of participating in a shared ride. Using the application 92, a user can view reservations that are available, such as vehicle ride availability information and/or vehicle renting availability information. The vehicle ride availability information can include information indicating times when the vehicle 12 is available for reservation or rental (including start and end times) (e.g., whether a ride is presently available), a ride arrival time estimate (i.e., an estimate of an amount of time until the vehicle used for the ride arrives at the user's location (if reserved)), a reservation or pickup location, a vehicle ride reservation price (or rate), vehicle specification information, vehicle reservation constraints (e.g., a maximum distance for the ride that the shared ride operator will provide), and other parameters concerning the prospective ride. The vehicle renting availability information can include information indicating times when the vehicle 12 is available for reservation or rental (including start and end times), a reservation or pickup location of the vehicle 12, a vehicle drop-off or return location, a vehicle reservation price (or rate), vehicle specification information, vehicle reservation constraints, and other parameters concerning the availability of the vehicle.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 20 are shown generally in FIG. 1 and includes a global navigation satellite system (GNSS) receiver 22, body control module or unit (BCM) 24, an engine control module (ECM) 26, other vehicle system modules (VSMs) 28, a wireless communications device 30, camera(s) 46, and vehicle-user interfaces 52-58. Some or all of the different vehicle electronics may be connected for communication with each other via one or more communication busses, such as bus 44. Communications bus 44 provides the vehicle electronics with network connections using one or more network protocols. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

The vehicle 12 can include numerous vehicle system modules (VSMs) as part of vehicle electronics 20, such as the GNSS receiver 22, BCM 24, ECM 26, wireless communications device 30, camera(s) 46, and vehicle-user interfaces 52-58, as will be described in detail below. The vehicle 12 can also include other VSMs 28 in the form of electronic hardware components that are located throughout the vehicle and, which may receive input from one or more sensors and use the sensed input to perform diagnostic, monitoring, control, reporting, and/or other functions. Each of the VSMs 28 is preferably connected by communications bus 44 to the other VSMs, as well as to the wireless communications device 30, and can be programmed to run vehicle system and subsystem diagnostic tests. One or more VSMs 28 may periodically or occasionally have their software or firmware updated and, in some embodiments, such vehicle updates may be over the air (OTA) updates that are received from a computer 78 or remote facility 80 via land network 76 and communications device 30. As is appreciated by those skilled in the art, the above-mentioned VSMs are only examples of some of the modules that may be used in vehicle 12, as numerous others are also possible.

Global navigation satellite system (GNSS) receiver 22 receives radio signals from a constellation of GNSS satellites. GNSS receiver 22 can be configured to comply with and/or operate according to particular regulations or laws of a given geopolitical region (e.g., country). The GNSS receiver 22 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 22 may be a GPS receiver, which may receive GPS signals from a constellation of GPS satellites 60. And, in another example, GNSS receiver 22 can be a BDS receiver that receives a plurality of GNSS (or BDS) signals from a constellation of GNSS (or BDS) satellites 60. In either implementation, GNSS receiver 22 can include at least one processor and memory, including a non-transitory computer readable memory storing instructions (software) that are accessible by the processor for carrying out the processing performed by the receiver 22.

GNSS receiver 22 may be used to provide navigation and other position-related services to the vehicle operator. Navigation information can be presented on the display 58 (or other display within the vehicle) or can be presented verbally such as is done when supplying turn-by-turn navigation. The navigation services can be provided using a dedicated in-vehicle navigation module (which can be part of GNSS receiver 22 and/or incorporated as a part of wireless communications device 30 or other VSM), or some or all navigation services can be done via the vehicle communications device (or other telematics-enabled device) installed in the vehicle, wherein the position information is sent to a remote location for purposes of providing the vehicle with navigation maps, map annotations (points of interest, restaurants, etc.), route calculations, and the like. The position information can be supplied to the vehicle backend services facility 80 or other remote computer system, such as computer 78, for other purposes, such as fleet management and/or for use in a shared ride service. Also, new or updated map data, such as that geographical roadway map data stored on databases 84, can be downloaded to the GNSS receiver 22 from the remote facility 80 via vehicle communications device 30.

Body control module (BCM) 24 can be used to control various VSMs of the vehicle, as well as obtain information concerning the VSMs, including their present state or status, as well as sensor information. BCM 24 is shown in the exemplary embodiment of FIG. 1 as being electrically coupled to communication bus 44. In some embodiments, the BCM 24 may be integrated with or part of a center stack module (CSM) and/or integrated with wireless communications device 30. Or, the BCM may be a separate device that is connected to other VSMs via bus 44. BCM 24 can include a processor and/or memory, which can be similar to processor 36 and memory 38 of wireless communications device 30, as discussed below. BCM 24 may communicate with wireless device 30 and/or one or more vehicle system modules, such as the engine control module (ECM) 26, inward-facing camera(s) 46, other cameras (e.g., outward-facing camera(s)), audio system 56, or other VSMs 28. BCM 24 may include a processor and memory accessible by the processor. Suitable memory may include non-transitory computer-readable memory that includes various forms of non-volatile RAM and ROM. Software stored in the memory and executable by the processor enables the BCM to direct one or more vehicle functions or operations including, for example, controlling central locking, air conditioning, power mirrors, controlling the vehicle primary mover (e.g., engine, primary propulsion system), and/or controlling various other vehicle modules. For example, the BCM 24 can send signals to other VSMs, such as a request to perform a particular operation or a request for sensor information and, in response, the sensor may then send back the requested information. And, the BCM 24 may receive data from VSMs, including image data from camera(s) 46, an occupant detection sensor, and various other information from other VSMs.

Additionally, the BCM 24 may provide vehicle state information corresponding to the vehicle state or of certain vehicle components or systems, including the VSMs discussed herein. For example, the BCM may provide the device 30 with information indicating whether the vehicle's ignition is turned on (as received from ECM 26, for example), the gear the vehicle is presently in (i.e. gear state), and/or other information regarding the vehicle. The sensor information and/or vehicle operating state information that is received or obtained at the BCM 24 can be used to detect and/or identify a shared ride member. This detecting/identifying may be carried out as part of various embodiments of the method discussed below. Sensor information (e.g., image data) and/or other information at the BCM 24 (e.g., shared ride member identification information) can be sent to the wireless communications device 30 (or other central vehicle computer) automatically upon receiving a request from the device/computer, or automatically upon certain conditions being met.

Engine control module (ECM) 26 may control various aspects of engine operation such as fuel ignition and ignition timing. ECM 26 is connected to communications bus 44 and may receive operation instructions from BCM 24 or other vehicle system modules, such as wireless communications device 30 or VSMs 28. In one scenario, the ECM 26 may receive a command from the BCM to start the vehicle—i.e., initiate the vehicle ignition or other primary propulsion system (e.g., a battery powered motor). The ECM 26 can also be used to obtain sensor information of the vehicle engine. In embodiments when the vehicle is a hybrid or electric vehicle, the ECM 26 can be used to obtain status information regarding the primary mover (including electrical motors and battery information).

The vehicle 12 includes various onboard vehicle sensors (e.g., camera 46), as well as certain vehicle-user interfaces that can be utilized as onboard vehicle sensors. Generally, the sensors can use their respective sensor (or sensing device) to obtain information pertaining to either the operating state of the vehicle (the “vehicle operating state”) or the environment of the vehicle (the “vehicle environmental state”). The sensor information can be sent to other VSMs, such as BCM 24 and the vehicle communications device 30, via communications bus 44. Also, in some embodiments, the sensor data can be sent with metadata, which can include data identifying the sensor (or type of sensor) that captured the sensor data, a timestamp (or other time indicator), and/or other data that pertains to the sensor data, but that does not make up the sensor data itself. The “vehicle operating state” refers to a state of the vehicle concerning the operation of the vehicle, which can include the operation of the primary mover (e.g., a vehicle engine, vehicle propulsion motors). Additionally, the vehicle operating state can include the vehicle state concerning mechanical operations of the vehicle—that is, the state of the mechanical operations of the vehicle. The “vehicle environmental state” refers to a vehicle state concerning the interior of the cabin and the nearby, exterior area surrounding the vehicle. The vehicle environmental state includes behavior of a driver, operator, or passenger, as well as traffic conditions, roadway conditions and features, and statuses of areas nearby the vehicle. The sensor information can be used to determine various shared ride metric data, as discussed more below.

Camera(s) 46 (only one shown) can each be an electronic digital camera that is powered through use of a vehicle battery. Although the vehicle can include a plurality of cameras 46, the camera 46 will be discussed with reference to a single camera and, thus, the discussion below shall apply to any one or more cameras of a plurality of cameras that may be used at a vehicle. The camera 46 can include a memory device and a processing device to store and/or process data that it captures or otherwise obtains. The data obtained by the camera 46 can be sent to another vehicle system module (VSM), such as wireless communications device 30 and/or BCM 24. The camera 46 may be of any suitable camera type (e.g., charge coupled device (CCD), complementary metal oxide semiconductor (CMOS), etc.) and may have any suitable lens known in the art. Some non-limiting examples of potential embodiments or features that may be used with the camera 46 include: infrared LEDs for night vision; wide angle or fish eye lenses; surface mount, flush mount, license mount, or side mount cameras; stereoscopic arrangements with multiple cameras; cameras integrated into tail lights, brake lights, or other components at the rear end of the vehicle; and wired or wireless cameras, to cite a few possibilities.

The camera 46 can be used to capture photographs, videos, and/or other information pertaining to light, which is collectively referred to herein as image data. The image data can be represented in a pixel array and can be captured using interlacing or progressive scanning techniques. The image data can be captured at a set or pre-configured scanning or sampling frequency, and may be configured to obtain image data of a particular resolution. Once the image data is obtained through using the camera 46, the image data can be processed and then sent to one or more other VSMs, including the wireless communications devices 30 and/or the BCM 24. The camera 46 can include processing capabilities that enable image processing techniques, including object recognition techniques, to be carried out at the camera. Or, in other embodiments, the cameras may send raw or formatted image data to another VSM, such as device 30 (or other central vehicle computer), which can then perform the image processing techniques.

One or more inward-facing cameras 46 can be installed and/or mounted on vehicle 12 and may be configured to face an area within an interior cabin of the vehicle 12, such as a passenger and/or operator cabin. In one embodiment, a first inward-facing camera 46 can be mounted on the vehicle such that the field of view of the camera faces a vehicle operator location (i.e., a location of the vehicle where an operator is positioned when properly operating the vehicle, such as in a driver's seat), while a second inward-facing camera can face a passenger location (e.g., front passenger seat, non-front-row vehicle seats). Additionally, multiple inward-facing cameras 46 can be positioned to face a particular area (e.g., the driver's seat) and, through using multiple cameras, multiple perspective or viewing angles of the particular area can be obtained, as well as stereoscopic information.

In one embodiment, multiple cameras can be positioned adjacent to one another and may be configured in a stereoscopic orientation such that video data is captured from multiple perspectives of an area and, when combined and processed according to a three-dimensional rendering algorithm, a three-dimensional reconstruction of the captured area may be rendered. A stereoscopic orientation refers to an orientation of multiple cameras such that their fields of view overlap thereby allowing multiple perspectives of the area to which their respective fields of view overlap.

In at least one embodiment, the image data obtained by the inward-facing cameras 46 can be processed according to image processing techniques, including object recognition techniques. In one particular embodiment, a first inward-facing camera 46 can be positioned so that the field of view of the camera 46 includes the vehicle operator location, which can be a region where the vehicle user's face will most likely be located. In this way, the first inward-facing camera 46 can obtain image data of the vehicle user's face when the vehicle operator, which may be a shared ride operator of the vehicle 12 (e.g., a vehicle renter or vehicle manager). Thereafter, the image data of the vehicle user's face can be processed using various face recognition techniques so as to recognize certain facial features or indications of the vehicle user's behavior. For example, image data of the vehicle user's face can be obtained and then analyzed using certain image recognition (or processing) techniques to identify a shared ride member. In one scenario, the camera 46 can obtain image data of a shared ride member's face and the images (and/or image recognition data) can be sent to the remote facility 80, which can then compare the image data and/or image recognition data (e.g., obtained from the vehicle 12, derived from the image data at the remote facility 80) to with facial recognition data stored in databases 84. The facial recognition data can be data that can be used to identify an individual (e.g., shared ride member) based on image data and/or image recognition data.

As mentioned above, in one embodiment, the remote facility 80 can then compare the recognized facial features of the vehicle user with facial recognition data (e.g., image data of the user's face, facial feature data) corresponding to the shared ride member so as to identify a particular individual as the shared ride member. The remote facility 80 can then notify the vehicle 12 of the identity of the shared ride member(s) and/or can notify personal SRWC devices of other shared ride member(s) and/or shared ride operators that are participating in the same shared ride. In some embodiments, this facial recognition step can also be used to authenticate that the shared ride members (or shared ride operator) of the vehicle 12. In some instances, once a shared ride member indicates their participation in a shared ride for a particular vehicle (e.g., via use of the shared ride member application 92, 94 of their personal SRWC device 90, 96), the remote facility 80 can send facial recognition data to the vehicle 12, which can then be used by the vehicle to identify and/or confirm the identity and/or presence of the shared ride member(s) at the vehicle. For example, image data obtained by inward-facing camera 46 can be used to generate facial recognition data, which can then be compared to the facility recognition data received from the remote facility 80.

Also, one or more outward-facing cameras can be installed and/or mounted on vehicle 12. According to a particular embodiment, a first camera can be mounted on the left side of the vehicle 12 and a second camera can be mounted on the right side of the vehicle 12. Additionally, or alternatively, a third camera can be mounted on the front of the vehicle (or at least facing the area in front of the vehicle) and a fourth camera can be mounted on the back of the vehicle (or at least facing the area behind the vehicle). For example, the first and second camera can be mounted on a side mirror and can be arranged so as to capture an area of the roadway. The third camera can be mounted on the rearview mirror and facing an area in front of the vehicle and/or can be mounted on another portion of the front of the vehicle, including areas on the outside of the vehicle. The fourth camera can be mounted on a rear exterior portion of vehicle 12 and, in some embodiments, the fourth camera can be used as a backup camera (or reversing camera) that is already included as a part of many consumer vehicles, including cars and trucks, or that may be required by one or more laws or regulations, including those regulations of the National Highway Traffic Safety Administration (NHTSA) that requires certain vehicles to include a backup camera. In one embodiment, the outward-facing cameras may be mounted on or embedded within a rear bumper of vehicle 12, a trunk or other rear door of vehicle 12, a tailgate (including those included in pickup trucks) of vehicle 12, a spoiler of vehicle 12, and/or any other location on vehicle 12 that is suitable for mounting or embedding camera 48 such that the field of view includes an area behind vehicle 12.

The outward-facing cameras can be used to detect the vehicle environmental state, including the presence of other vehicles, the roadway conditions and features, and various other information. The image data obtained from the outward-facing cameras can be used to obtain information concerning collisions, incidences where collisions almost occurred (e.g., the distance from the vehicle to other vehicles), and the presence and nature of other, nearby vehicles. For example, the outward-facing cameras 48 can use image recognition techniques to determine that an emergency vehicle (e.g., ambulance) is approaching the vehicle 12 from behind (such as through use of the fourth outward-facing camera) and this information can be used in conjunction with vehicle state information to determine the quality of care exercised in navigating out of the path of the emergency vehicle so as to not obstruct the emergency vehicle's path. In one embodiment, the outward-facing camera(s) can be used to identify and/or detect the presence of one or more individuals (e.g., shared ride members) at the vehicle using those techniques discussed above with respect to the inward-facing camera 46.

Additionally, the vehicle 12 can include other sensors not explicitly mentioned above, including passive entry passive start (PEPS) sensors (and/or a PEPS module), door ajar sensors (i.e., sensors that detect whether a vehicle door is open or closed), parking sensors, lane change and/or blind spot sensors, lane assist sensors, ranging sensors (i.e., sensors used to detect the range between the vehicle and another object, such as through use of radar or lidar), tire-pressure sensors, fluid level sensors (including a fuel level sensor), brake pad wear sensors, V2V communication unit (which may be integrated into the wireless communications device 30, as discussed below), rain or precipitation sensors, and interior or exterior temperature sensors.

Wireless communications device 30 is capable of communicating data via short-range wireless communications (SRWC) and/or via cellular network communications, as depicted in the illustrated embodiment. In one embodiment, the wireless communications device 30 is a central vehicle computer that is used to carry out at least part of the method discussed below. In the illustrated embodiment, wireless communications device 30 includes an SRWC circuit 32, a cellular chipset 34, a processor 36, memory 38, and antennas 33 and 35. In one embodiment, wireless communications device 30 may be a standalone module or, in other embodiments, device 30 may be incorporated or included as a part of one or more other vehicle system modules, such as a center stack module (CSM), body control module (BCM) 24, an infotainment module, telematics unit, a head unit, and/or a gateway module. In some embodiments, the device 30 can be implemented as an OEM-installed (embedded) or aftermarket device that is installed in the vehicle. In some embodiments, the wireless communications device 30 is a telematics unit (or telematics control unit) that is capable of carrying out cellular communications using one or more cellular carrier systems 70. In one embodiment, the telematics unit and/or the wireless communications module 30 can be integrated with the GNSS receiver 22 so that, for example, the GNSS receiver 22 and the wireless communications device (or telematics unit) 30 are directly connected to one another as opposed to being connected via communications bus 44.

In some embodiments, the wireless communications device 30 can be configured to communicate wirelessly according to one or more short-range wireless communications (SRWC) such as any of the Wi-Fi™, WiMAX™, Wi-Fi Direct™, other IEEE 802.11 protocols, ZigBee™, Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 32 enables the wireless communications device 30 to transmit and receive SRWC signals, such as BLE signals. The SRWC circuit may allow the device 30 to connect to another SRWC device. Additionally, in some embodiments, the wireless communications device 30 contains the cellular chipset 34 thereby allowing the device to communicate via one or more cellular protocols, such as those used by cellular carrier system 70 and, thus, in at least one embodiment, the wireless communications device is considered user equipment (UE) usable in carrying out cellular communications via cellular carrier system 70.

Wireless communications device 30 may enable vehicle 12 to be in communication with one or more remote networks (e.g., one or more networks at remote facility 80 or computers 78) via packet-switched data communication. This packet-switched data communication may be carried out through use of a non-vehicle wireless access point that is connected to a land network via a router or modem. When used for packet-switched data communication such as TCP/IP, the communications device 30 can be configured with a static IP address or can be set up to automatically receive an assigned IP address from another device on the network such as a router or from a network address server.

Packet-switched data communications may also be carried out via use of a cellular network that may be accessible by the device 30. Communications device 30 may, via cellular chipset 34, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel. Data can be sent either via a data connection, such as via packet data transmission over a data channel, or via a voice channel using techniques known in the art. For combined services that involve both voice communication and data communication, the system can utilize a single call over a voice channel and switch as needed between voice and data transmission over the voice channel, and this can be done using techniques known to those skilled in the art.

Processor 36 can be any type of device capable of processing electronic instructions including microprocessors, microcontrollers, host processors, controllers, vehicle communication processors, and application specific integrated circuits (ASICs). It can be a dedicated processor used only for communications device 30 or can be shared with other vehicle systems. Processor 36 executes various types of digitally-stored instructions, such as software or firmware programs stored in memory 38, which enable the device 30 to provide a wide variety of services. For instance, processor 36 can execute programs or process data to carry out at least a part of the method discussed herein and/or a shared ride vehicle application. Memory 38 may be a powered temporary memory or any suitable non-transitory, computer-readable medium; these include different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), and magnetic or optical disc drives. Similar components to those previously described (processor 36 and/or memory 38) can be included in body control module 24 and/or various other VSMs that typically include such processing/storing capabilities.

The wireless communications device 30 can provide an interface between various VSMs of the vehicle 12 and one or more devices external to the vehicle 12, such as the personal SRWC devices 90, 94. This enables various vehicle operations to be carried out by “extra-vehicle” devices (or non-vehicle devices), including the personal SRWC device 90 and the vehicle backend services facility 80. These extra-vehicle devices are electronic devices that are not a part of the vehicle electronics 20 and that are not including as a part of the vehicle system. In one embodiment, the wireless communications device 30 can receive sensor data from one or more onboard vehicle sensors and, thereafter, the vehicle can send this data (or other data derived from or based on this data) to other devices or networks, including the personal SRWC device 90 and the vehicle backend services facility 80.

In one embodiment, the wireless communications device 30 can be incorporated with (or at least connected to) a navigation system that includes geographical map information including geographical roadway map data. The navigation system can be communicatively coupled to the GNSS receiver 22 (either directly or via communications bus 44) and can include an on-board geographical map database that stores local geographical map information. This local geographical map information can be provisioned in the vehicle and/or downloaded via a remote connection to a geographical map database/server, such as computer 78 and/or remote facility 80 (including servers 82 and databases 84). The on-board geographical map database can store geographical map information corresponding to a location or region of the vehicle so as to not include a large amount of data, much of which may never be used. Moreover, as the vehicle enters different locations or regions, the vehicle can inform the vehicle backend services facility 80 of the vehicle's location (e.g., obtained via use of GNSS receiver 22) and, in response to receiving the vehicle's new location, the servers 82 can query databases 84 for the corresponding geographical map information, which can then be sent to the vehicle 12.

Vehicle electronics 20 also includes a number of vehicle-user interfaces that provide vehicle occupants with a means of providing and/or receiving information, including pushbutton(s) 52, microphone 54, audio system 56, and display 58. As used herein, the term “vehicle-user interface” broadly includes any suitable form of electronic device, including both hardware and software components, which is located on the vehicle and enables a vehicle user to communicate with or through a component of the vehicle. Vehicle-user interfaces 52-54 and 58 are also onboard vehicle sensors that can receive input from a user or other sensory information, which can be used to determine shared ride metrics and/or shared ride cost metrics. The pushbutton(s) 52 allow manual user input into the communications device 30 to provide other data, response, or control input. Audio system 56 provides audio output to a vehicle occupant and can be a dedicated, stand-alone system or part of the primary vehicle audio system. According to the particular embodiment shown here, audio system 56 is operatively coupled to both vehicle bus 44 and an entertainment bus (not shown) and can provide AM, FM and satellite radio, CD, DVD and other multimedia functionality. This functionality can be provided in conjunction with or independent of an infotainment module. Microphone 54 provides audio input to the wireless communications device 30 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 58 is preferably a graphics display and can be used to provide a multitude of input and output functions. Display 58 can be a touch-screen on the instrument panel, a heads-up display reflected off of the windshield, or a projector that can project graphics for viewing by a vehicle occupant. In one embodiment, the display 58 is a touch-screen display that can receive input from one or more vehicle users (e.g., shared ride members) via detecting a touch of a user on the touch-screen. Various other vehicle-user interfaces can also be utilized, as the interfaces of FIG. 1 are only an example of one particular implementation.

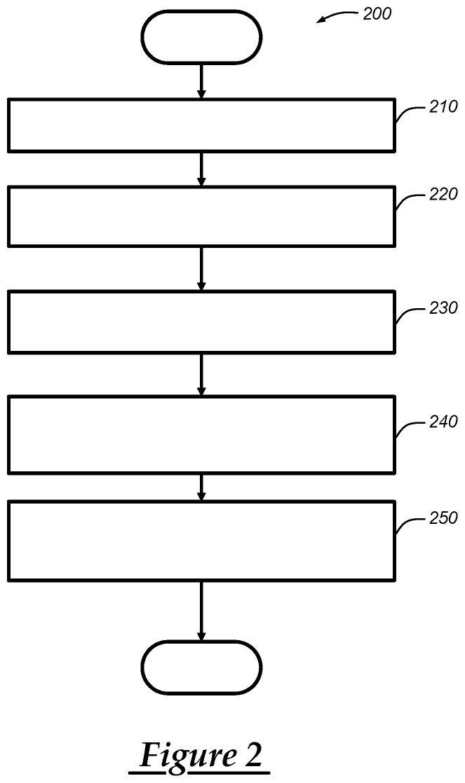

With reference to FIG. 2, there is shown a method 200 of determining a shared ride metric for a plurality of shared ride members of a shared ride. In one embodiment, the method 200 can be carried out by the remote facility 80, such as by one or more servers 82 of the remote facility 80. In another embodiment, the method 200 can be carried out by the vehicle electronics 20, such as by one or more VSMs of the vehicle 12. And, in another embodiment, one or more steps of the method 200 can be carried out by the remote facility 80 and one or more steps of the method 200 can be carried out by the vehicle 12. Although the steps of the method 200 are described as being carried out in a particular order, it is hereby contemplated that the steps of the method 200 can be carried out in any technically feasible order as will be appreciated by those skilled in the art.

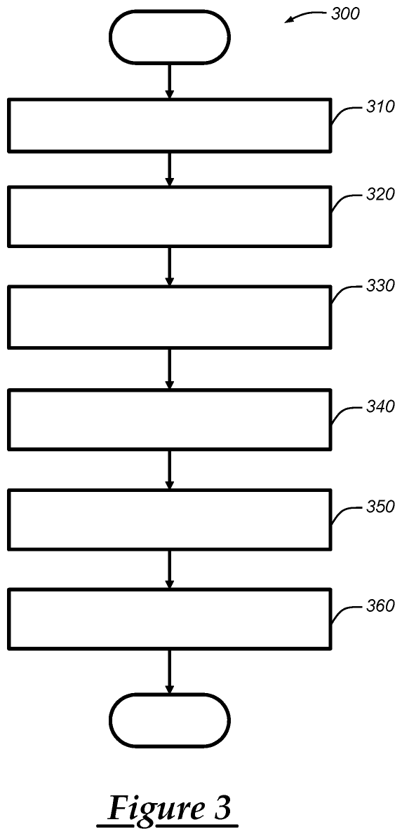

As mentioned above, the method 200 or the method 300 (FIG. 3) can be used in the context of a shared ride reservation. A shared ride reservation refers to both reservations for car sharing services and for ride sharing services. The term “car sharing” refers to any service by which an individual (or individuals) may reserve or rent a car (or other vehicle) for use and operation where the individual that reserved the vehicle is the shared ride operator. In such embodiments, the shared ride operator is also a shared ride member for purposes of the shared ride reservation. The term “ride sharing” refers to any service by which an individual (or individuals) reserves or procures a ride in a vehicle, such as a taxi service, an UBER™, a LYFT™, or other similar service by which the individuals are not the shared ride operator (or at least primary shared ride operator). In such embodiments, the shared ride operator is not a shared ride member since the shared ride operator is providing services for purposes of providing a ride to the shared ride members.

The method 200 begins with step 210, wherein a shared ride reservation for the shared ride is established. In one embodiment, a first user can use the personal device 90 to request a shared ride reservation, such as a car sharing reservation or a ride sharing reservation. In other embodiments, another device can be used by the first user to request a reservation (e.g., computer 78). This shared ride reservation request can be sent to the remote facility 80 via wireless carrier system 70 and/or land network 76. The remote facility 80 can then determine whether to accept (or establish) a shared ride as requested in the shared ride reservation request. As a part of establishing the reservation, the remote facility 80 can send a message to the vehicle 12 that queries the vehicle for information, such as the vehicle's location. Or, in another embodiment, such as when the shared ride reservation is being used to request a ride sharing service, the remote facility 80 can send a message to the vehicle 12 or a personal SRWC device of the shared ride service provider (or operator). The shared ride service provided (or operator) can then send a confirmation (or a denial) message back to the remote facility that confirms (or denies) the reservation request. The method 200 continues to step 220.

In step 220, it is determined whether more than one shared ride member is participating in the shared ride. In one embodiment, the remote facility 80 can determine that more than one member is participating in the shared ride based on receiving information from one or more personal SRWC devices. For example, as a part of establishing the reservation, the first user can specify a number of shared ride members participating in the shared ride and/or the identity of the individuals participating in the shared ride as shared ride members. This information can be sent from the personal SRWC device to the remote facility 80. In another example, a second user can request to be linked to (or to be recognized as joining) the reservation through using the shared ride member application of their personal SRWC device. This information specifying the number of shared ride members and/or identifying the other users can be sent to the vehicle 12 from the remote facility 80. In another embodiment, the vehicle can detect individuals at the vehicle (in addition to the shared ride operator and/or shared ride service provider) (e.g., detecting the presence of personal SRWC devices at the vehicle) and this information can be sent to the remote facility 80 from the vehicle 12. The remote facility 80 (and/or vehicle) can then determine whether more than one (or a plurality of) individuals are participating in the shared ride as shared ride members. When it is determined that more than one shared ride member is participating in the shared ride, the method 200 continues to step 230; otherwise, the method 200 ends.

In step 230, it is determined whether more than one shared ride member is contributing to a total shared ride payment. The total shared ride payment is the total amount of payment that is due for the shared ride. In one embodiment, as a default, it can be assumed that each shared ride member is contributing to the total shared ride payment. Additionally or alternatively, the remote facility 80 (or the vehicle 12) can present a prompt to one or more of the shared ride members (e.g., the primary shared ride member, all shared ride members) that queries how many (and which) shared ride members will be contributing to the total shared ride payment. The shared ride members that are contributing to the total shared ride payment can be referred to as shared ride contributing members. In one embodiment, all of the shared ride members are shared ride contributing members; however, in other embodiments, only some of the shared ride members are shared ride contributing members.

In one embodiment, the shared ride contributing members can be identified at the beginning (or prior to the beginning) of the shared ride. However, in some scenarios, shared ride members (including shared ride contributing members) may later join the shared ride, as discussed more below. In such embodiments, this determination (or step 230) can be made at a time when another shared ride member joins or becomes linked to the shared ride. Moreover, at this time, step 240 can be carried out for the newly joined shared ride member—that is, in some embodiments, when it is determined that more than one shared ride member is contributing to the total shared ride payment, then a shared ride metric for at least one shared ride contributing member can be determined at the time (or a time after) the joining (or linking) of the shared ride member. Once the number and/or identities of the shared ride members that are contributing to the total shared ride payment are identified, the method 200 continues to step 240.

In step 240, a shared ride metric is determined for each of the shared ride contributing members. In one embodiment, the shared ride metric can be a cost metric, a shared ride participation time, or a shared ride participation mileage. The cost metric can be a metric or value that is used to determine an amount attributed to a shared ride member for purposes of the shared ride. The shared ride participation time and the shared ride participation mileage are discussed more below. In one embodiment, the cost metric can be a percentage (e.g., a total cost percentage (i.e., a percentage of the total amount due)) or a dollar (or other currency) amount. In some embodiments, the cost metric(s) for each shared ride member can be determined before the shared ride is carried out, at the start or beginning of the shared ride, during the shared ride, and/or after the shared ride.

In one embodiment, the shared ride contributing members can agree on cost metrics for one another and can enter this information into their personal SRWC devices and/or the vehicle using one or more vehicle-user interfaces, such as the touch-screen display 58. For example, each shared ride member can use their shared ride member application (e.g., applications 92, 96) to enter a cost metric (e.g., a dollar amount, a total cost percentage) into a graphical user interface (GUI) presented by the personal SRWC device on its display. In some embodiments, the remote facility 80 (or vehicle 12) can suggest cost metrics for each of the shared ride members. For example, as an initial cost metric suggestion, the total cost can be split evenly (or approximately evenly such as in the case of a total price that includes an odd penny amount (e.g., $3.47 is split to $1.74 and $1.73)) based on the number of shared ride members. In other embodiments, a single user interface can be used to entire the cost metric, such as through use of touch-screen display 58 at the vehicle 12 or through use of a personal SRWC device of a shared ride member (e.g., one of the shared ride contributing members, the primary shared ride contributing member).

In one embodiment the cost metric can represent shared ride member shares for each shared member contributing member. The shared ride member shares can be a number identifying how many shared ride members that a shared ride contributing member is going to pay for (or planning on paying for). For example, in a scenario where three shared ride members are participating in the shared ride, two of the three shared ride members can be identified as (or determined to be) shared ride contributing members. One of the shared ride contributing members can be associated with two shared ride member shares and the other shared ride contributing member can be associated with one shared ride member share. In such a case, it can be said that the first shared ride contributing member is paying for both himself/herself and the non-contributing shared ride member. The method 200 continues to step 250.

In step 250, each shared ride contributing member is notified of an associated shared ride cost. The term “associated shared ride cost” refers to an amount due (e.g., a dollar amount that is due) for a particular shared ride member (or shared ride contributing member) of a shared ride. In many embodiments, the associated shared ride cost is based on the associated cost metric that was determined in step 240. In some scenarios, the associated shared ride cost may be the same as the associated cost metric. However, in other scenarios, the cost metric may be a percentage of a total overall cost, which may be calculated or determined at the end of the shared ride. For example, when a first shared ride member has an associated cost metric of 35%, a second shared ride member has an associated cost metric of 65%, and the total shared ride cost is $100.00, then the associated shared ride cost for the first shared ride member can be determined to be $35.00 and the associated shared ride cost for the second shared ride member can be determined to be $65.00.

In one embodiment, each shared ride member (or each shared ride contributing member) is notified of an associated shared ride cost after step 240, but before the end of the shared ride (e.g., during the shared ride, before the shared ride). In another embodiment, each shared ride member (or each shared ride contributing member) is notified of an associated shared ride cost at the end of the shared ride. In some embodiments, the notification can be generated by the remote facility or the vehicle upon determining that the shared ride has ended or upon determining that the associated shared ride cost has been finalized. In one embodiment, the notification can be sent from the remote facility 80 to the associated personal SRWC devices for each shared ride member (or each shared ride contributing member) directly (i.e., without being sent via the vehicle); in other embodiments, the notification can be sent from the remote facility 80 to the associated personal SRWC devices for each shared ride member (or each shared ride contributing member) via the vehicle electronics. For example, in this latter embodiment, the remote facility 80 can send the associated shared ride cost to the wireless communications device 30 (or a separate telematics unit of the vehicle) and then the vehicle 12 can use the SRWC circuit 32 to send the notification to the associated personal SRWC devices for each shared ride member. Or, in another embodiment, the vehicle 12 can use any of the vehicle-user interfaces (e.g., display 58) to present the notification(s) to the shared ride members. The method 200 then ends.

With reference to FIG. 3, there is shown a method 300 of determining a shared ride metric for a plurality of shared ride members of a shared ride. Method 300 can be carried out by remote facility 80 and/or the vehicle 12 (e.g., using one or more VSMs of the vehicle electronics, such as the wireless communications device 30 and/or the BCM 24). Moreover, the servers 82 located at the remote facility 80 and the personal SRWC devices 90, 94 can be used in conjunction with the vehicle 12 to carry out the method 300. Various other embodiments exist, as will be apparent from the discussion below in light of the discussion of system 10 provided above. Although the steps of the method 300 are described as being carried out in a particular order, it is hereby contemplated that the steps of the method 300 can be carried out in any technically feasible order as will be appreciated by those skilled in the art. Moreover, any technically feasible combination of one or more of the steps of the method 200 and one or more of the steps of the method 300 is hereby contemplated.

The method 300 begins with step 310, wherein a shared ride reservation for the shared ride is established. This step corresponds to step 210 of the method 200 (FIG. 2) and, that discussion above is applicable to step 310. In one embodiment, a first user (or prospective shared ride member) can request and/or establish a reservation through using the shared ride member application 92 on their personal SRWC device 90. As mentioned above, the shared ride member application 92 can be a ride sharing application and/or a car sharing application, and the first user can view reservations that are available (e.g., viewing vehicle ride availability information, vehicle renting availability information). In one embodiment, the first user can then select or request a reservation of a particular vehicle and a reservation request can be generated and sent to the remote facility 80. One of the servers 82 at the remote facility 80 can receive the reservation request and, using a shared ride backend services application (for example), the reservation can be confirmed (or accepted) by the remote facility 80.

In one embodiment, as a part of confirming or accepting the reservation, the remote facility 80 can communicate with the vehicle 12. For example, the remote facility 80 can send a request for information to the vehicle 12 and, in response, the vehicle 12 can send a response back to the remote facility. The request can prompt the vehicle to confirm information for use in the prospective reservation, such as prompting the vehicle to confirm its location. In another embodiment, the remote facility 80 can forward the reservation request to the vehicle 12 and/or personal SRWC device of the vehicle operator (as in the case of a ride sharing service). This reservation request can be sent with information pertaining to the first user and/or their requested reservation (e.g., a start and end location, the number of passengers, additional stops). The shared ride operator can then indicate whether to accept or deny the prospective reservation. This indication can then be sent to the remote facility 80, which can then forward the indication to the personal SRWC device 90 of the first user.

In some embodiments, a plurality of shared ride members can participate in a single shared ride and one or more of the plurality of shared ride members can take part in establishing the reservation. In one embodiment, the first user can request a shared ride (or shared ride reservation) and, once the reservation request is submitted to the remote facility 80, other users (such as a second user) can view and join (or become linked to) the reservation request. In other embodiments, the second user (and/or other users) can join the reservation after the first user successfully establishes the reservation (and after the first user has been identified (step 320) and linked to the shared ride (step 230)). And, in some embodiments, user(s) may join (or become linked to the share ride) after the reservation begins. For example, a shared ride member can reserve (or rent) a vehicle for a particular rental period. During the rental period, the shared ride member may share the vehicle with other shared ride members and, thus, these individuals can join (or become linked to the share ride) the shared ride reservation. As used herein, “join” or “joining” refers to requesting to taking part in a shared ride that already exists or which has been (or is in the process of being) established. For example, a user that is entering a vehicle used in a shared ride can be considered a user that is joining the shared ride. A primary shared ride member can be identified and/or determined based on information received from the remote facility 80, the personal SRWC devices of the shared ride members, or the vehicle 12. This primary shared ride member can be an individual that takes primary responsibility for certain aspects of the rental or vehicle. The personal SRWC device of the primary shared ride member can also be identified and referred to as the primary personal SRWC device.

In one embodiment, the first and second users can be associated with one another due to one or both of the users selecting to be associated with one another (e.g., adding each other as friends on the applications 92, 96) or as a result of having shared past rides with one another. In such cases, once the first user requests and/or establishes a shared ride reservation, the application 96 of the second user can be notified and a prompt can be presented (e.g., on a display of the personal SRWC device) that asks whether the second user desires or is going to join the shared ride of the first user. And, in some embodiments, this notification or prompt can be sent from the remote facility 80 based on determining that the second user is co-located with the first user, or can be received at the second personal SRWC device 94 using SRWC communications between the devices 90 and 94. The method 300 continues to step 320.

In step 320, individuals are identified as being at the vehicle. As mentioned above, a plurality of shared ride members can participate in a single shared ride (or shared ride reservation). In one embodiment, this step can be carried out as a part of the step 220 of the method 200 (FIG. 2). In one embodiment, at or around the time of a shared ride reservation (e.g., at the start of the shared ride reservation) the vehicle 12 can use various onboard vehicle sensors (e.g., camera 46, wireless communications device 30) to gather information concerning one or more individuals at the vehicle. This gathered information can then be used to determine whether the identified individual(s) are participating in the shared ride. This determination can be made at the vehicle based on information received at the vehicle from the remote facility 80 and/or the personal SRWC device(s) of the identified individual(s), or the gathered information can be sent to the remote facility 80 and this determination may be made at the remote facility 80.

In at least some embodiments, the shared ride members (or other individuals (e.g., potential subjects of the shared ride)) can be identified at the vehicle 12 through use of one or more onboard vehicle sensors, such as the camera 46. In one embodiment, a first inward-facing camera 46 is mounted on the vehicle and positioned so that the field of the view of the first camera 46 includes a location in which a vehicle driver's head is likely located when the driver is positioned in the driver's seat. Alternatively or additionally, in one embodiment, a second inward-facing camera 46 is mounted on the vehicle and positioned so that the field of the view of the second camera 46 includes a location in which a vehicle passenger's (e.g., front-seat passenger, back-seat passenger) head is likely located when riding in the vehicle 12. In another embodiment, an outward facing camera can be used to identify individuals approaching and departing the vehicle 12.

In embodiments that use the camera 46 (or other cameras) for identification, the camera 46 can capture image data, which can then be processed using facial recognition techniques as discussed above. In one embodiment, the facial recognition can be carried out at the vehicle 12 through use of information received from the remote facility 80. Or, in other embodiments, the facial recognition can be carried out at the remote facility 80 using the captured image data that is sent from the vehicle 12. Once the remote facility 80 identifies one or more individuals appearing in the captured image data, shared ride membership accounts for the identified individuals can be confirmed and this confirmation (including the identities of the individuals (e.g., identification information)) can be communicated to the vehicle 12. In one embodiment, the status of the shared ride members can be determined as well. For example, the first camera 46 that faces the driver's (likely) head/face location can be associated with certain image data and, after the individual is identified (e.g., using the facial recognition techniques), it can be determined that this individual is the shared ride operator. In the case of ride sharing, the driver (and use of a camera facing the driver's likely head/face location) may not be identified.

Alternatively or additionally, other techniques can be used to identify the shared ride members (or potential shared ride members), such as through use of the shared ride member application 92, 96. For example, when a second user holding a personal SRWC device (e.g., device 94) arrives at the vehicle (or comes within a predetermined distance of the vehicle 12), the second personal SRWC device 94 can send a SRWC message to the wireless communications device 30 that indicates the second user's presence at the vehicle. This SRWC message can include an identifier of the user, an identifier of the personal SRWC device, an identifier used with the shared ride member application 96, and/or other information used to identify (or indicate the presence of) the second user. Then, in some embodiments, information contained in the SRWC message can be sent to the remote facility 80.

In other embodiments, an individual (or user) can send a message to a remote facility 80 using their personal SRWC device (e.g., using application 92 of device 90) indicating their desire to join the shared ride. This message (or subsequent message(s)) that is sent from the personal SRWC device to the remote facility 80 can include information identifying the user, such as an identifier of the personal SRWC device or shared ride membership account information. The remote facility 80 can then communicate identification of the individual to the vehicle 12. Also, the personal SRWC device can send location information to the remote facility 80, which can then determine whether the user of the personal SRWC device (and/or whether the personal SRWC device) is at the same location as the vehicle 12 and/or a distance between the vehicle 12 and the personal SRWC device. The personal SRWC device location information can be gathered based on a GNSS receiver including in the personal SRWC device, and the vehicle location information can be gathered by the GNSS receiver 22 and sent to the remote facility 80. The method 300 continues to step 330.

In step 330, each shared ride member becomes linked to the shared ride. The term “link to the shared ride” and its various forms refers to associating a particular individual (e.g., a shared ride member) with the shared ride such that the particular individual is identified as a shared ride member of the shared ride reservation. Although step 330 is depicted in the illustrated embodiment as being carried out after step 320, in some embodiments, step 330 can be carried out before step 320. And, in some embodiments, step 320and step 330 can be carried out in one order (e.g., step 320 then step 330) for one individual (e.g., an individual that later joins a shared ride) and in a different order (e.g., step 330 then step 320) for a second individual (e.g., an individual that establishes the shared ride reservation). In one embodiment, the shared ride members can each be linked to the shared ride at the same time (or around the same time), such as at the start of the shared ride or at the time of initializing the reservation. However, in some instances, individuals may later join the shared ride and, thus, at the time of joining (and/or identifying the newly-joined shared ride member), the individual may become linked to the shared ride.

In one embodiment, the linking of the individual to the shared ride can be carried out in response to the identification of an individual at the vehicle and/or in response to determining that the identified individual is participating in the shared ride as a shared ride member, such as that which is described in step 320 above. For example, the remote facility 80 can identify the individual(s) based on facial recognition (or through receiving a message from an associated personal SRWC device), determine a shared ride membership account for the identified individual, and then establish a link between the identified individual and the shared ride. The link can merely be storing information that identifies the identified individual as a shared ride member of the shared ride.

In another embodiment, once the shared ride member is linked to the shared ride, a notification can be sent to a personal SRWC device that is associated with the shared ride member. This notification can inform the shared ride member application that the user has been linked to a shared ride. At this time, the user can verify this link through using the shared ride member application. In some embodiments, the verification can include the user entering security information, such as a password or a pin (e.g., a 4 or 6 digit pin). The verification can be communicated back to the remote facility 80, which can then notify the vehicle 12 that the user has been linked to the shared ride.

In some embodiments, a shared ride member may be linked to the shared ride before being identified at the vehicle (step 320) and, in such cases, the identity of the shared ride member can be confirmed based on their determined identity. The confirmation can be carried out at the vehicle 12 and/or the remote facility 80, and can include determining that identification information for an individual identified at the vehicle (e.g., facial recognition data) matches (or corresponds to) identification information for one of the shared ride members. The method 300 continues to step 340.

In step 340, a shared ride metric for each shared ride member is determined. This step corresponds to step 240 of the method 200 (FIG. 2) and, that discussion above is applicable to step 340. In one embodiment, the shared ride metric can be a cost metric, a shared ride participation time, or a shared ride participation mileage. As mentioned above, this step can be carried out at the beginning of the shared ride and/or during the shared ride. For example, shared ride member(s) may join the shared ride during the shared ride period and, thus, in some embodiments, the cost metric for those newly joined shared ride member(s) can be made at the time that they join the shared ride or at the time that they are linked to the shared ride.

In some embodiments, each shared member can be associated with a loyalty information. This loyalty information can be determined by the remote facility based on the identities of the shared ride members. Once determined, the loyalty information can be communicated to the vehicle 12 via the land network 76 and/or the wireless carrier system 70. The vehicle 12 can store the loyalty information at memory 38 (or other memory that is a part of the vehicle electronics 20). In one embodiment, the loyalty information is a loyalty status and, based on the loyalty status, the associated shared ride member is limited to a maximum or minimum cost metric threshold. For example, when a first shared ride member is of a higher loyalty status than a second shared ride member, the second shared ride member may only be permitted to enter a cost metric that is above a cost metric minimum threshold. In another embodiment, the shared ride member with a higher loyalty status can be presented with a dollar amount deduction, which can be applied after the shared ride members enter their cost metric. The shared ride member application can also offer the shared ride member with the higher loyalty status the option of splitting the discount with one or more of the other shared ride member(s).

In another embodiment, the shared ride member occupant with a lower loyalty pays a larger percentage of the shared ride total cost due and/or the shared ride member with the higher loyalty pays a discounted or reduced percent. And, in another embodiment, the shared ride member with the lower loyalty may pay a larger service fee or other fee, and/or the fee may be reduced or removed for the shared ride member with the higher loyalty status. In some embodiments, these discounts can be applied to an even split of the total cost due. In cases where the shared ride members have the same loyalty status, then an equal split of the total cost can be used. The method 300 continues to step 350.

In step 350, each shared ride member is notified of an associated shared ride cost (or cost metric). This step corresponds to step 250 of the method 200 (FIG. 2) and, that discussion above is hereby incorporated. The term “associated shared ride cost” refers to an amount due (e.g., a dollar amount that is due) for a particular shared ride member of a shared ride. In many embodiments, the associated shared ride cost can be based on the associated cost metric that was determined in step 340. In some scenarios, the associated shared ride cost may be the same as the associated cost metric. However, in other scenarios, the cost metric may be a percentage of a total overall cost, which may be calculated or determined at the end of the shared ride. For example, when a first shared ride member has an associated cost metric of 35%, a second shared ride member has an associated cost metric of 65%, and the total shared ride cost is $100.00, then the associated shared ride cost for the first shared ride member can be determined to be $35.00 and the associated shared ride cost for the second shared ride member can be determined to be $65.00.

In one embodiment, each shared ride member is notified of an associated shared ride cost after step 340, but before the end of the shared ride (e.g., during the shared ride, before the shared ride). In another embodiment, each shared ride member is notified of an associated shared ride cost at the end of the shared ride. In some embodiments, the notification can be generated by the remote facility or the vehicle upon determining that the shared ride has ended or upon determining that the associated shared ride cost has been finalized. In one embodiment, the notification can be sent from the remote facility 80 to the associated personal SRWC devices for each shared ride member directly (i.e., without being sent via the vehicle); in other embodiments, the notification can be sent from the remote facility 80 to the associated personal SRWC devices for each shared ride member via the vehicle electronics. For example, in this latter embodiment, the remote facility 80 can send the associated shared ride cost to the wireless communications device 30 (or a separate telematics unit of the vehicle) and then the vehicle 12 can use the SRWC circuit 32 to send the notification to the associated personal SRWC devices for each shared ride member. Or, in another embodiment, the vehicle 12 can use any of the vehicle-user interfaces (e.g., display 58) to present the notification(s) to the shared ride members. The method 300 continues to step 360.

In step 360, each shared ride member can confirm the associated shared ride cost. In one embodiment, a shared ride member can confirm the associated shared ride cost through using the shared ride member application (e.g., applications 92, 96). For example, the personal SRWC devices 90, 94 can present the notification (or an indicator of the associated shared ride cost) on a display of the personal SRWC device as well as a “Confirm” button (e.g., an interactive graphical object). The shared ride member can then select the “Confirm” button, which then causes the personal SRWC device to send a confirmation message to the remote facility 80. In one embodiment, the confirmation message can be sent first to the vehicle 12 via SRWC, and then from the vehicle 12 to the remote facility 80 via the wireless carrier system 70 and/or the land network 76. In other embodiments, the confirmation message can be sent directly to the remote facility 80 via the wireless carrier system 70 and/or the land network 76. At this time, the remote facility 80 can charge the shared ride member's membership account. The method 300 then ends.

In other embodiments, the cost metric(s) and/or the associated shared ride cost(s) can be based on detection of a shared ride member's presence at the vehicle. For example, the vehicle can track the amount of time that each shared ride member participated in the shared ride (the “shared ride participation time”). Then, at the end of the shared ride, a cost metric and/or an associated shared ride cost for a particular shared ride member can be determined based on the shared ride participation time for the particular shared ride member as compared to the shared ride participation time for the other shared ride members. For example, it can be determined that a first user has a shared ride participation time of 1.5 hours and a second user has a shared ride participation time of 0.5 hours for a shared ride. The first shared ride member can then be allocated a cost metric of 75% and the second shared ride member can be allocated a cost metric of 25%. The total cost can be $100 and, thus, the associated shared ride cost for the first shared ride member is $75 and the associated shared ride cost for the second shared ride member is $25.

In some embodiments, the shared ride participation time can be determined based on information received from the vehicle. For example, the vehicle can determine a start time for a particular shared ride member based on when the vehicle (and/or the remote facility) identifies the shared ride member as entering (or first becoming detectable) at the vehicle. Or, in another embodiment, the vehicle 12 can detect the presence of the personal SRWC device for a particular shared ride member at the vehicle. In one embodiment, the personal SRWC device can respond to a SRWC signal sent by the vehicle (e.g., a beacon signal) and, based on the response, the vehicle can identify the personal SRWC device and/or the user (e.g., shared ride member) based on information received from the remote facility 80. Then, upon the shared ride member departing the vehicle with their personal SRWC device, the vehicle 12 can detect the absence (or a disconnection) of the personal SRWC device and, thus, can determine that the shared ride member is no longer at the vehicle. This technique can be used in conjunction with (or as an alternative to) other identification/presence detection mechanisms, such as those discussed above with respect to the camera 46.

In another embodiment, instead of (or in addition to) keeping track of each shared ride members' participation time, the vehicle 12 and/or the remote facility 80 can keep track of or determine a shared ride participation mileage. The shared ride participation mileage is the mileage (or distance) (e.g., kilometers, miles) that each shared ride member traveled as a participant in the shared ride. For example, it can be determined that a first user has a shared ride participation mileage of 75 miles and a second user has a shared ride participation time of 25 miles for a shared ride. The first shared ride member can then be allocated a cost metric of 75% and the second shared ride member can be allocated a cost metric of 25%. The total cost can be $100 and, thus, the associated shared ride cost for the first shared ride member is $75 and the associated shared ride cost for the second shared ride member is $25. And, in another embodiment, shared ride participation mileage and shared ride participation time can both be determined and used to determine the associated shared ride cost for each shared ride member.

In another embodiment, the shared ride members' presence at the vehicle and/or time spent as a shared ride member of the shared ride can be determined through user input received at the shared ride member application (e.g., applications 92, 96) or at the vehicle 12. For example, a shared ride member can provide an input to the personal SRWC device (e.g., using a touch-screen display) or to the vehicle 12 (e.g., using the touch-screen display 58, button 52). This input can be used to indicate when a shared ride member has arrived at or when a shared ride member has departed from the vehicle. These inputs can be used for purposes of determining shared ride participation mileage and/or shared ride participation time.

In one embodiment, the method 200, the method 300, and/or parts thereof can be implemented in a computer program (or “application”) embodied in a computer readable medium and including instructions usable by one or more processors of one or more computers of one or more systems. The computer program may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media (e.g., memory at servers 82, memory 38 of the wireless communications device 30, memory of BCM 24, memory of an infotainment unit), which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

1. A method of determining a shared ride metric for a plurality of shared ride members of a shared ride, the method comprising:
establishing a shared ride reservation for the shared ride;
determining that more than one shared ride member is participating in the shared ride such that a plurality of shared ride members are participating in the shared ride; and
when it is determined that more than one shared ride member is participating in the shared ride:
determining a shared ride metric for two or more of the plurality of shared ride members, each of the shared ride metrics being associated with one of the two or more shared ride members; and
notifying each of the two or more shared ride members of an associated shared ride cost based on the associated shared ride metric.

2. The method of claim 1, further comprising the step of determining whether more than one shared ride member is contributing to a total shared ride payment, wherein each of the shared ride member(s) that are contributing to the total shared ride payment is a shared ride contributing member.

3. The method of claim 2, when it is determined that more than one shared ride member is contributing to the total shared ride payment, then determining a shared ride metric for at least one shared ride contributing member, and wherein the two or more shared ride members are the shared ride contributing members.

4. The method of claim 3, wherein the shared ride metrics for each of the two or more shared ride members is a shared ride cost metric.

5. The method of claim 4, wherein the shared ride cost metric is or represents a proportion of a total shared ride payment for the shared ride.

6. The method of claim 5, wherein the shared ride cost metric is or represents shared ride member shares.

7. The method of claim 4, wherein the associated shared ride cost is or is the same as the shared ride cost metric.

8. The method of claim 4, wherein the shared ride cost metric for each of the two or more shared ride members is determined based on receiving input information from at least one of the two or more shared ride members, and wherein the input information is generated at the vehicle using a vehicle user interface and/or at one or more personal short-range wireless communications (SRWC) devices of the at least one shared ride member.

9. The method of claim 8, wherein the input information is received at a remote facility from the vehicle or from the one or more personal SRWC devices, and wherein the remote facility carries out the step of determining the shared ride cost metric for each of the two or more shared ride members.

10. The method of claim 1, further comprising the step of identifying one or more individuals at the vehicle based on information received from one or more onboard vehicle sensors, and wherein the step of determining that more than one shared ride member is participating in the shared ride is based on the identifying step.

11. The method of claim 10, wherein the one or more onboard vehicle sensors includes a camera mounted on the vehicle, wherein the identifying step includes processing image data obtained by the camera at a remote facility.

12. The method of claim 1, wherein the method is carried out by a remote facility that includes one or more servers, and wherein each of the one or more servers includes a processor and memory.

13. The method of claim 12, wherein the processor of at least one of the one or more servers is configured to carry out a shared ride backend services application, the shared ride backend services application including computer instructions that, when executed by the processor of at least one server, causes the remote facility to carry out the method.

14. A method of determining a shared ride metric for a plurality of shared ride members of a shared ride, the method comprising:
establishing a shared ride reservation for the shared ride;
identifying two or more of the plurality of shared ride members that are participating in the shared ride;
when more than one shared ride member is identified as participating in the shared ride, obtaining a shared ride metric for each of the two or more identified shared ride members, each of the shared ride metrics being associated with one of the two or more shared ride members; and
notifying each of the two or more shared ride members of an associated shared ride cost based on the associated shared ride metric.

15. The method of claim 14, wherein the identifying step includes linking each of the plurality of shared ride members to the shared ride as each of the plurality of shared ride members are identified.

16. The method of claim 14, wherein the identifying step includes identifying at least one of the two or more shared ride members based on information indicating a presence of a personal short-range wireless communications (SRWC) device associated with the at least one shared ride member at the vehicle.

17. The method of claim 14, wherein each of the shared ride metrics is based on associated loyalty information.

18. The method of claim 14, wherein the shared ride metric is obtained based on onboard vehicle sensor information.

19. The method of claim 18, wherein each of the shared ride metrics is a shared ride participation time or a shared ride participation mileage.

20. The method of claim 14, further comprising the step of confirming the associated shared ride cost through receiving a confirmation message from one or more of the two or more shared ride members.
